(19) United States
(12) Patent Application Publication
(10) Pub. No.: US 2009/0235595 A1
(43) Pub. Date: Sep. 24, 2009

(54) FACADE GLAZING ELEMENT AND FACADE GLAZING COMPRISING SUCH AN ELEMENT

(75) Inventor: Christian Walch, Nuziders (AT)

Correspondence Address: MORRISS OBRYANT COMPAGNI, P.C., 734 EAST 200 SOUTH, SALT LAKE CITY, UT, 84102, US

(73) Assignee: WALCH AG, Eschen (LI)

(21) Appl. No.: 12/299,747

(22) PCT Filed: Dec. 22, 2006
(86) PCT No.: PCT/CH2006/000728

§ 371 Date: Nov. 5, 2008

(30) Foreign Application Priority Data
Dec. 23, 2005 (CH) 2079/05

(51) Int. Cl. E04B 2/90; E06B 3/56

(52) U.S. Cl. 52/235; 52/309.3

(57) ABSTRACT

The present invention relates to a facade glazing element having a stepped glazing with a first and a second windowpane (13, 15), wherein the dimensions of the first windowpane (13) exceed those of the second windowpane (15) by a specified amount. The first and second windowpanes (13, 15) are each firmly bonded at their edge to a mounting frame (35) made of wood or wood-based material by means of a first and a second adhesive layer (37, 39). On the mounting frame (35) is provided a room-side fastening possibility or fastening means for fastening the facade glazing to a facade. By virtue of the room-side fastening possibility for the facade glazing element, disassembly is possible without damaging the surrounding components or connections to the building, thereby making repair glazing, for example, easily possible.

### TECHNICAL FIELD OF THE INVENTION

The present invention relates to a façade glazing element having stepped glazing with at least a first (outer) and a second (inner) window pane, the dimensions of the first window pane exceeding the second window pane by a certain amount, hereinafter also referred to as “overlap”, and relates to façade glazing using the façade glazing element.

### PRIOR ART

A metal/glass façade is known from GB-A-2 167 784. It is formed from a bearing frame and a few support frames for a double glazing. The bearing frame is formed by horizontal and vertical metal hollow profiles. The support frames are formed by metal profiles in which insulating glazing has been glued. These metal profiles for the support frames for the glazing are stepped, the outer glass of the insulating glazing being glued to a first step and having outer dimensions that are at least equal to the outer dimensions of the support frame. The inner glass of the insulating glazing is glued to the second step of the metal profile. The metal profile possesses an arm that projects inward from the inner glass and that can be placed from outside over the hollow profile of the bearing frame and screwed thereto. Inserted between the bearing frame for the façade and the support frame for its glazing are nylon profiles that are called screw anchors. The support frame can be clicked over these nylon profiles from outside and is held by them until fixation by means of screws. The fixation screws are screwed into the hollow profile of the bearing frame parallel to the glazing plane on the inside of the insulating glazing through the arm of the metal profile of the support frame, which arm extends inward, and through the screw anchor.

There is a need, particularly in housing construction, to be able to produce such whole glass facades as wood structures, as well.

Known from DE-U-203 09 960 is a façade glazing with wood frame windows. This façade glazing includes fixed glazing and window wings. The outer glass pane of the insulating glazing used is larger than the inner glass pane. This stepped glass is glued into the wood frame, for the window wing it is glued into the wing frame, and for the fixed glazing it is glued into the window frame. The outer glass pane in the fixed glazing and also in the closed position for the wing glazing is placed on a rubber seal that is anchored in a metal profile. This metal profile is screwed to the side of the window frame. The window frame is joined to the building. It follows from the aforesaid that the fixed glazing can only be mounted in the window frame from the outside and, in order to exchange glazing, the adhesive join between the fixed glazing and the window frame has to be removed and therefore it is highly probable that the window frame will be damaged.

### OBJECT OF THE INVENTION

Proceeding from this prior art is the object of providing an improved façade glazing as a wood structure that can be mounted with little complexity. Another goal is to improve the fastening of the glazing such that fixed glazing elements can be exchanged without having to damage the bearing structure. It is also desirable to be able to do without outer scaffolding.

### DESCRIPTION OF THE INVENTION

In accordance with the invention, the object is attained using a façade glazing element in accordance with the preamble to claim 1 and using a façade glazing in accordance with claim 7. In an inventive façade glazing element, the wood frame into which the stepped glazing is glued is a mounting frame that can be removed from the bearing structure. The first window pane and the second window pane are each securely glued on the edge to the mounting frame by means of a first and a second adhesive agent layer, and on the room side there is a fastening option or fastening device on the mounting frame for fastening the façade glazing to a façade. The inventive façade glazing element has the advantage that it can be fastened to a bearing structure and can also be released from it from inside. This means that no scaffolding is necessary for mounting or replacing the element. Another advantage of the façade glazing element is that its stepped glazing is securely joined to the mounting frame by adhesive agent at two annular perimeter locations that are disposed in two planes spaced apart from one another. Thus the risk that the glazing could loosen is greatly reduced compared to the known façade glazing glued to wood frames.

Although the mounting frame can comprise solid wood with its grown structure over the entire cross-section of the frame profile, it is still advantageously made of plywood. Plywood has the advantage that it is a more cost-effective material that has only low heat conductivity but compared to solid wood has greater loading capacity and lower warpage. In accordance with one preferred embodiment, in its cross-section the mounting frame has an L-profile having two legs, this defining a rabbet for receiving the stepped glass. The first window pane is usefully securely glued to the end face of the one leg and the second window pane is securely glued to the inside or flank of the second leg oriented toward the first leg. A particularly stable and stiff bond can be created by the two adhesive bonds in two planes that are separated from one another and that are between the double glazing and the mounting frame.

Usefully, the mounting frame and the stepped glazing have practically the same dimensions. Therefore the mounting frame is approximately aligned with the edges of the first window pane around the perimeter. This permits a plurality of façade glazing elements to be arranged adjacent to and/or above one another. The fastening option or fastening device is advantageously provided on the mounting frame jamb. This makes it possible to secure the façade glazing element to a bearing structure on the room side of the window pane. For fastening the façade glazing element, a plurality of holes for receiving fastening means can be provided on the mounting frame jamb. These extend parallel to the glazing through the mounting frame. Alternatively bolts, pins, or screws can be inserted perpendicular to the glazing and can then engage in the bearing structure and can be mounted, screwed, or bolted on the room side.

The subject-matter of the present invention is also a façade glazing having a bearing structure in which a façade opening is formed for receiving a façade glazing element, into which façade opening the façade glazing element is placed as fixed glazing.

For fastening the façade element, the mounting frame has a recess, opposite the jamb, embodied on two opposing sides or even around the perimeter, so that there is for instance an S profile in the area with the recess. In addition, the bearing structure has a projection that projects at a right angle to the window opening, maximally the size of the recess, so that the façade glazing element with the recess abuts the projection. Thanks to the overlapping of the mounting frame and the projection, it is possible to screw or bolt the mounting frame to the projection. The bearing structure is advantageously embodied at least on two opposing sides of the façade glazing element. For smaller façade glazing elements, a bearing structure that is present on only two opposing sides is adequate for sufficient fastening. Preferably the façade glazing element is screwed, bolted, pinned, or anchored to the bearing structure through the mounting frame jamb. However, it is also conceivable for screws, bolts, or the like to be used, at a right angle to the window glazing, that can engage the bearing structure in corresponding holes. The screws or bolts can then be fastened on the room side using a tightening element that is similar to a tightening element used for furniture.

The subject-matter of the present invention is also a method for producing a fixed façade glazing that includes the following method steps:

Producing a façade glazing (bond) element by producing a mounting frame made of wood or wood material having certain dimensions; producing a stepped glazing matched to the dimensions of the mounting frame and, by joining stepped glazing and mounting frame and gluing the edge of the stepped glazing to the mounting frame, providing a bearing structure, that has a façade opening that corresponds to the size of the façade glazing element;

From the outside, placing the façade glazing element into the façade opening and screwing, bolting, or mounting it on the room side to the bearing structure. The inventive method has the advantage that these façade glazing elements that form a fixed glazing can be produced independent from the bearing structure and can be joined thereto at the construction site without screwing or gluing from the outside. Thus no scaffolding is necessary to place the façade glazing element into the façade opening. Furthermore, the façade glazing elements can be replaced at any time without it being necessary to impact adjacent glazing elements or even the bearing structure.

The invention is described in greater detail in the following, with reference to the figures, using an exemplary application. The same numbers are used to identify identical parts in the figures.

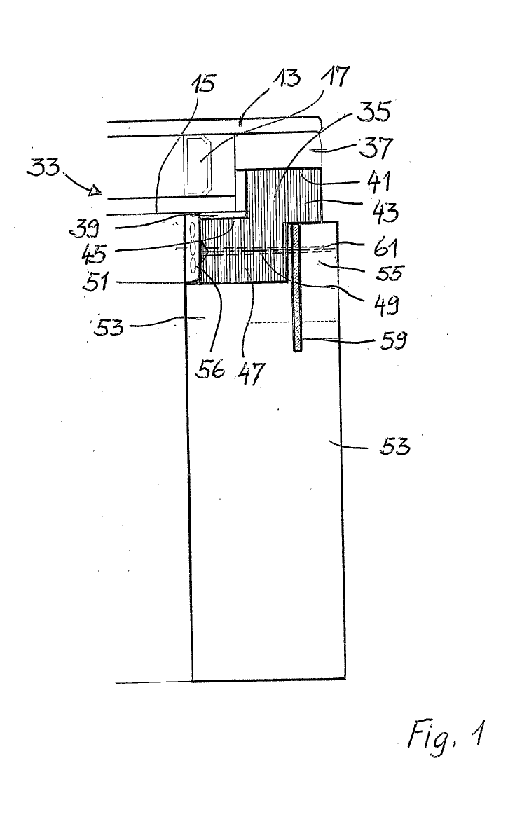

FIG. 1 is a schematic depiction and horizontal section of a detail view of an inventive façade glazing element fastened to a bearing structure;

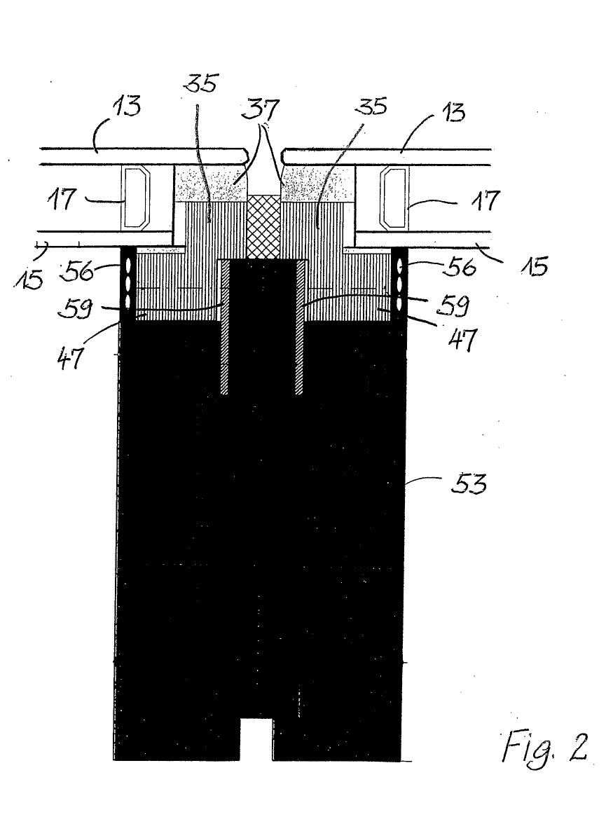

FIG. 2 is a detail view of an inventive façade glazing having two façade glazing elements abutting one another;

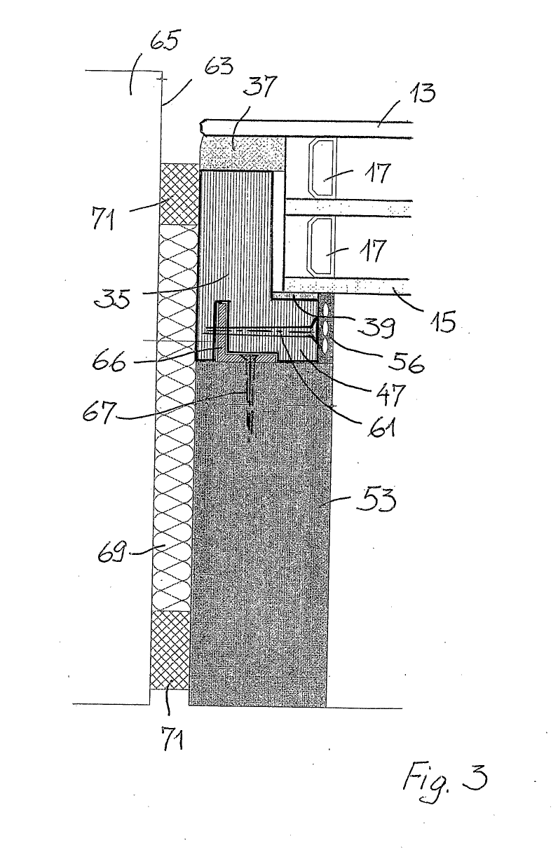

FIG. 3 is another variant of an inventive fixed façade glazing having triple glazing;

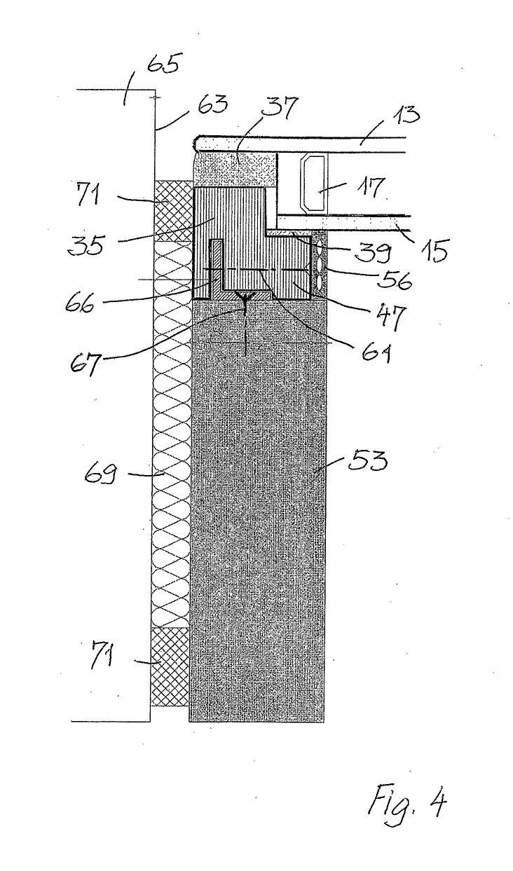

FIG. 4 is the same variant as in FIG. 3, but with double glazing.

The fixed façade glazing depicted in FIGS. 1 and 2 has a façade glazing element 33 with a stepped insulating glazing (hereinafter also referred to simply as “stepped glass”) having an outer window pane 13 and an inner window pane 15. Outer and inner window panes 13, 15 are securely glued to one another by means of a spacer element 17. The façade glazing element 33 is securely joined to a mounting frame 35 by means of a first and a second adhesive agent layer 37, 39. The mounting frame 35 has an L profile, the first adhesive agent layer 37 being disposed between the end face 41 of the first leg 43 and the outer window pane 13 and the second adhesive agent layer 39 being disposed on the inside 45 of the second leg 47.

Adhesive agents that can be used for joining the glass and wood can be double-sided adhesive tapes or reactive adhesives, for instance. In particular the inner adhesive bond can be formed by a double-sided adhesive tape. The outer adhesive bond can be formed by a heat-reactive polyurethane adhesive or by a silicone or ac late-based two-component adhesive (also reactive adhesives). When hardened the adhesive usefully ensures tensile shear strength that is greater than 1 MPa. However, the maximum tensile shear strength is preferably 12 MPa. Experiments have demonstrated that the adhesive should have a maximum Shore hardness of A 90 or D 50 to attain the best possible noise damping for the façade elements.

A bore hole 49 that receives a fastening screw 61 runs through the end face 51 of the second leg 47.

The façade glazing element 33, with the mounting frame 35, is mounted on a bearing structure 53. The bearing structure 53 can be a post, a wall, or for instance a frame. The bearing structure 53 has a projection 55 against which the mounting frame 35 can be positioned. In accordance with the depicted exemplary embodiment, the mounting frame 35 has a recess 57 that corresponds approximately to the dimensions of the projection 53 [sic] so that the assembly frame 35 can be positioned in a form fit against the projection 55. Screws, bolts, or other fastening elements are screwed into the projection 55 through the end face 51 and the bore hole 49 for fastening the façade glazing element 33 to the bearing structure 53. This type of fastening has the advantage that it can be performed from the interior of the room. The end face 51 of the second leg can be covered with a cover strip 56.

Preferably the mounting frame comprises plywood. Plywood has the advantage that it has poor heat conductivity but good stability. In addition, there are commercially available adhesives that permit a reliable bond, that is stable for the long term, between mounting frame and window pane. Since the projection 55 must be able to deflect the entire wind load, an additional reinforcing element 59 can be provided for glazings that have a poor surface-to-perimeter ratio. The reinforcing element can be for instance a metal plate, a strip of sheet metal, an angle bar, or other means that have the same effect.

As can be seen from FIG. 2, a plurality of façade glazing elements can be arranged adjacent to one another. However, it is also conceivable to alternate fixed façade glazing elements with windows that can be opened.

FIG. 3 depicts a variant of a fixed façade glazing that is used in a wall opening 63 of a façade wall 65. In contrast to the first exemplary embodiment, the mounting frame 35 is held by an angle bar 66. The angle bar 66 is screwed to the bearing structure 53 by means of screws 67. The window glazing element is itself securely screwed to the angle bar 66 by the screws 61. It is also clear from the described example that the window glazing can also include more than two window panes. An insulating material 69 is present between the façade glazing element and the façade wall 65. A sealing strip 71 is inserted both inside and outside in the gap between the façade wall 65 and the façade glazing element, which prevents water from penetrating. FIG. 4 depicts the same embodiment, but with only double glazing.

The present invention relates to a façade glazing element having a stepped glazing with a first and a second window pane, the dimensions of the first window pane exceeding the second window pane by a certain amount. The first and the second window panes are each securely glued on the edge to a mounting frame by means of a first and a second adhesive agent layer. A room-side fastening option or fastening device is provided on the mounting frame for fastening the façade glazing to a façade. Thanks to the room-side fastening option for the façade glazing element, disassembly is possible without damaging the surrounding components or connections to the building, so that for instance simple repair glazings are possible

### LEGEND

11 Façade glazing
13 Outer window pane
15 Inner window pane
17 Adhesive layer
19 Metal profile
21 Claw
23 Pocket
25 Screw
27 Post
29 Sealing tape
31 Silicone joint
33 Inventive façade glazing element
35 Mounting frame
37 First adhesive agent layer
39 Second adhesive agent layer
41 End face of the first leg
43 First leg of the L profile
45 Inside of the second leg
47 Second leg
49 Bore hole
51 End face of the second leg
53 Bearing structure
55 Projection
57 Recess
59 Reinforcing element
61 Fastening screw
63 Wall opening
65 Façade wall
67 Screws
69 insulating material
71 Sealing strip

What is claimed is:

1. A façade glazing element for a fixed glazing comprising:
a stepped glazing with at least a first, outer window pane and a second, inner window pane, said outer window pane projecting beyond said second window pane by an overlap, and the stepped glazing being glued to an outside of a wood frame arranged on a room side;
said first window pane is securely glued on its edge, by a first adhesive agent layer, and the second window pane securely glued on its edge, by a second adhesive agent layer, to a mounting frame made of wood or wood material; and
on the room side of the stepped glazing a fastening option or fastening device is provided on said mounting frame for fastening the façade glazing element to a bearing structure.

2. The façade glazing element in accordance with claim 1, wherein said mounting frame is made of plywood.

3. The façade element in accordance with claim 1, wherein the wood profile of said mounting frame has a solid wood cross-section.

4. The façade glazing element in accordance with claim 1, wherein in its cross-section said mounting frame has a rabbet, defined by first and second legs, for receiving said stepped glass, and said first window pane is securely glued to an end face of said first leg and said second window pane is securely glued to a flank of said second leg oriented toward said first leg.

5. The façade glazing element in accordance with claim 1, wherein said mounting frame and said first window pane have recesses corresponding to one another such that said mounting frame is approximately aligned with edges of said first window pane around the perimeter.

6. The façade glazing element in accordance with claim 1, wherein parallel to the plane of the glazing a plurality of holes is provided through the mounting frame for receiving fastening means.

7. A façade glazing, comprising:
a bearing structure that defines a façade opening for receiving a fixed glazing;
a façade glazing element is placed into said façade opening, said façade glazing element including a stepped glazing having at least a first, outer window pane and a second, inner window pane glued to a wood frame, said outer window pane projecting beyond said inner window pane by an overlap;
the wood frame comprising a mounting frame that can be detached from said bearing structure, said first window pane securely glued on its edge, by a first adhesive agent layer, and the second window pane securely glued on its edge, by a second adhesive agent layer, to said mounting frame; and
said mounting frame fastened to the bearing structure on a room side of the stepped glazing.

8. The façade glazing in accordance with claim 7, wherein said bearing structure is positioned on at least two opposing sides of said façade glazing element.

9. The façade glazing in accordance with claim 7, wherein said mounting frame has a recess on at least two opposing sides accessible from an inside of the façade glazing, said bearing structure having a projection that projects at a right angle to a window opening, and the façade glazing element placed into the window opening such that the projection reaches into the recess.

10. The façade glazing in accordance with claim 7, wherein the façade glazing element is screwed, bolted, pinned, or anchored to said bearing structure through the jamb of the mounting frame parallel to a glazing plane.

11. The façade glazing in accordance with claim 7, wherein screws, bolts or threaded rods are provided on the end face of said mounting frame oriented to a room side that are perpendicular to a glazing plane and engage in corresponding holes in the bearing structure and can be screwed, bolted, pinned, or anchored on the room side.

12. The façade glazing in accordance with claim 9, wherein said bearing frame is comprised of wood and the projection on said bearing frame is formed by a metal profile or includes a metal profile.

13. The façade glazing in accordance with claim 12, wherein said metal profile is embedded in said bearing frame.

14. The façade glazing in accordance with claim 13, wherein said metal profile is a flat band.

15. The façade glazing in accordance with claim 12, wherein said metal profile comprises an angle or a Z profile.
